(19) United States
(12) Patent Application Publication
(10) Pub. No.: US 2025/0339324 A1
(43) Pub. Date: Nov. 6, 2025

(54) Sliding Transfer Bench with Leg Support

(71) Applicant: Frish Limited Liability Company, Southbury, CT (US)

(72) Inventors: Richard Bloc, Derchigny (FR); Sabine Hairabedian, Manhasset, NY (US); Liam O'Keeffe, Southbury, CT (US)

(21) Appl. No.: 18/650,197

(22) Filed: Apr. 30, 2024

(51) Int. Cl. A61G 7/10; A47K 3/12

(52) U.S. Cl. CPC A61G 7/1003; A47K 3/122; A61G 7/1025; A61G 7/1096

(57) ABSTRACT

A mechanical leg rest, and a sliding transfer bench comprising the mechanical leg rest are provided to elevate the legs of the user mechanically, electrically, or with other sources of energy so he or she can enter a bathtub without having to lift his or her legs. The leg rest comprises a leg rest support configured to move between an extended position and a retracted position and configured to support a user's legs when in the extended position; an actuator configured to extend and retract linearly upon activation by an activating device; and a chassis configured to connect the leg rest support to the actuator and configured to translate linear motion of the actuator into an arcuate motion of the leg rest support in between the extended position and the retracted position.

### FIELD OF THE INVENTION

The present application relates to a leg rest and more particularly, to a retractable leg rest mechanism.

### BACKGROUND OF THE DISCLOSURE

A sliding transfer bench is a tub or shower bench chair with a metal frame extending into the tub and outside of the tub to plant the chair to the floor, allowing a person to slide in the chair into and out of a bathtub. Examples of sliding transfer benches known in the art include those shown and described in U.S. Pat. Nos. 7,506,385, 7,980,584, or 10,694,897.

### SUMMARY OF THE DISCLOSURE

The present application improves upon the state of the art by providing a mechanical leg rest to elevate the legs of the user mechanically, electrically, or with other sources of energy so he or she can enter the bathtub wall without having to lift his or her legs. This makes entering and exiting the bathtub easier for anyone experiencing pain or a loss of mobility, either temporarily, after surgery, or more permanently.

A device of the application comprises: a seat on a frame, with height-adjustable legs, which slides on horizontal rails from outside the bathtub to inside. The seat can be locked during loading for safety reasons then unlocked when sliding on the rails. The seat may or may not swivel. The leg rest design may include a vertical surface or support that gets raised horizontally or a support that comes out from underneath the seat and extends to lift the legs and then retracts.

In the resting position, the whole leg rest mechanism is tucked away under the seat in a retracted position so the user can access the seat with no obstruction, which can be sideways access if transferring from a wheelchair, or otherwise from the front. When the user is seated on the seat, the leg rest mechanism can be activated by one of a plurality of possible actuating mechanisms, such as: an electric actuator powered either by a rechargeable battery or by connecting it to a wall outlet; a hydraulic actuator system; a pneumatic actuator device such as an air piston; or a mechanical system operated by the user or a caregiver, such as a lever, a gear mechanism, a crank, a pedal or the like. The extension mechanism allows transformation of the linear stroke of the actuator (movement of translation) into an elliptical movement of the rollers to allow their contact on the legs high enough (to accommodate a whole range of users) and their rotation along the leg so there is no excessive friction on a given spot of the legs. This can be important because the skin of users with mobility issues, such as elderly or handicapped individuals, or individuals recovering from surgery, can be very delicate and friction needs to be minimized or avoided. With this mechanism, the point of contact of the rollers moves along the leg and provides support while delivering a very smooth, controlled motion to extend the legs horizontally. The rollers are made of a soft material that provides a very comfortable experience for the user.

The two levers can be U-shaped and are part of the mechanism controlling the trajectory of the leg rest to provide stability while amplifying the stroke of the actuator so the rollers can travel all the way to the lower leg (even to the ankle on shorter users) and provide adequate support. In its “extended” position, the leg rest is horizontal and can therefore clear any obstacle such as the wall of a bathtub (specifically for the bath transfer bench application).

In accordance with a first aspect of the present application, an apparatus is provided. The apparatus comprises: a leg rest support, configured to move between an extended position and a retracted position and configured to support a user's legs when in the extended position; an actuator configured to extend and retract linearly upon activation by an activating device; and a chassis configured to connect the leg rest support to the actuator and configured to translate linear motion of the actuator into an arcuate motion of the leg rest support in between the extended position and the retracted position.

Implementations of the apparatus of the first aspect of the application may include one or more of the following features. The leg rest support of the apparatus may include one or more rollers arranged thereon, configured to roll along the user's legs during movement of the leg rest support.

In embodiments of the apparatus, the chassis of the apparatus may include at least one opening therethrough. The linear motion of the actuator translates to the first lever to cause the arcuate motion of the chassis and leg rest support. The chassis further may include a second opening therethrough configured to receive a pin of a second lever; the second lever being mounted to the leg rest mount. The first lever and second lever can be U-shaped.

The apparatus may include a chamber into which a rod of the actuator extends and retracts.

The activating device of the actuator may be electrically powered and may include a rechargeable battery; or it may be hydraulically powered; or it may be mechanically powered.

The apparatus of the first aspect of the application may include: a leg rest mount configured to mount the apparatus to another structure; and a clevis, configured to mount the actuator to the leg rest mount, and configured to rotate upon linear movement of the actuator and the arcuate motion of the leg rest support.

In accordance with a second aspect of the present application, a sliding transfer bench is provided. The sliding transfer bench comprises: a bench seat; a bench frame on which the bench seat rests and along which the bench seat is configured to slide laterally; and a leg rest. The leg rest may comprise: a leg rest support, configured to move between an extended position and a retracted position and configured to support a user's legs when in the extended position; an actuator configured to extend and retract linearly upon activation by an activating device; and a chassis configured to connect the leg rest support to the actuator, and configured to translate linear motion of the actuator into an arcuate motion of the leg rest support in between the extended position and the retracted position.

In embodiments of the sliding transfer bench of the present application, the leg rest support may include one or more rollers arranged thereon, configured to roll along the user's legs during movement of the leg rest support. The chassis may include at least one opening therethrough. The linear motion of the actuator translates to the first lever to cause the arcuate motion of the chassis and leg rest support. The chassis further may include at least a second opening therethrough configured to receive a pin of a second lever; the second lever being mounted to the leg rest mount. The sliding transfer bench may include: a clevis, configured to mount the actuator to the leg rest mount, and configured to rotate upon linear movement of the actuator and the arcuate motion of the leg rest support.

### BRIEF DESCRIPTION OF THE FIGURES

FIG. 1 shows a perspective view of a sliding transfer bench according to the present application;

FIG. 2 shows a top view of a sliding transfer bench according to the present application;

FIG. 3 shows a front view of a sliding transfer bench according to the present application;

FIG. 4 shows a side, cross-sectional view along axis B-B of a seat of a sliding transfer bench according to the present application;

FIG. 5 shows a side view of a sliding transfer bench according to the present application;

FIG. 6A shows a bottom perspective view of a leg rest mechanism in a retracted position, according to the present application;

FIG. 6B shows a bottom perspective view of a leg rest mechanism in an extended position, according to the present application;

FIG. 7 shows a side view of a sliding transfer bench according to the present application, with the leg rest transitioning from a retracted to an extended position; and

FIGS. 8A-8D show side views of a user seated on a sliding transfer bench according to the present application, with the leg rest transitioning from a retracted to an extended position.

### DETAILED DESCRIPTION OF THE FIGURES

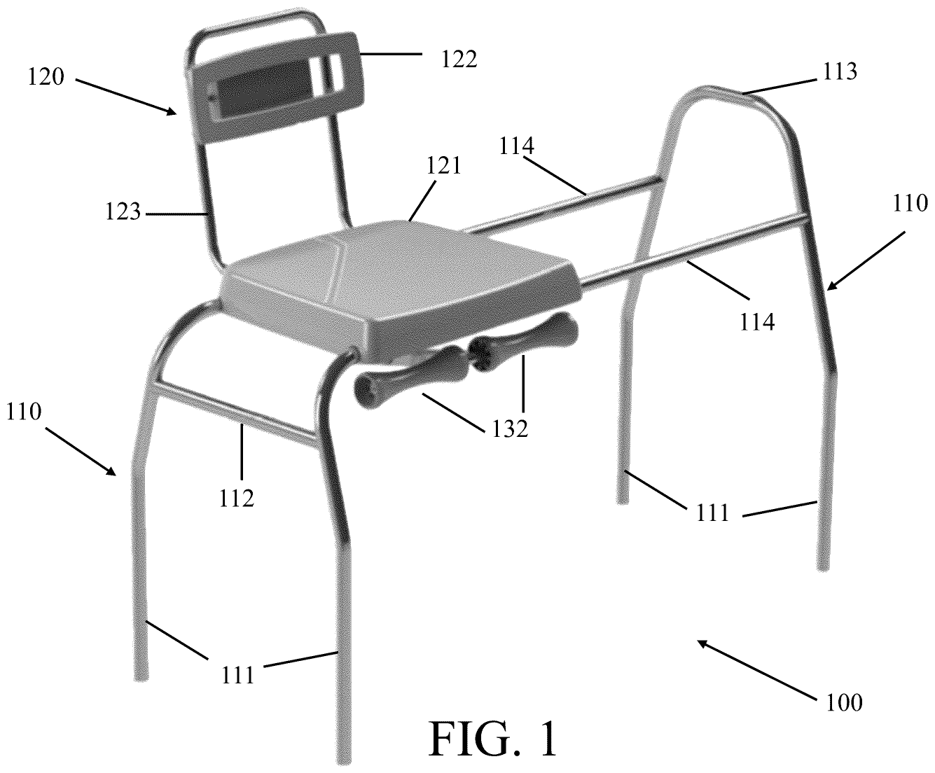

The apparatus and system of the present application will now be described with reference made to FIGS. 1-8D.

FIGS. 1-3 illustrate an example of a sliding transfer bench 100 including a retractable leg rest 130 according to the present application. The sliding transfer bench 100 generally comprises a bench frame 110, a seat 120, and the retractable leg rest 130. In use for example, the sliding transfer bench 100 may be placed partially inside a bathtub or shower, with one lateral end positioned inside the bathtub or shower and the other lateral end positioned outside the bathtub or shower. The seat 120 is configured to slide laterally along the bench frame 110, such that the user can sit on the seat 120 outside of the bathtub or shower, then slide laterally on the bench frame 110, while in the seat 120, to enter the bathtub or shower without having to step or climb over the bathtub or shower wall. The leg rest 130 is provided to lift the user's legs over the bathtub or shower wall without requiring the physical exertion otherwise needed by the user to lift their legs to such a height. The lateral motion of the seat 120 on the bench frame 110 also works in reverse, allowing a user to exit the shower by sliding on the seat 120 in the opposite direction.

The bench frame 110 provides the sliding transfer bench 100 with a frame or skeletal structure that supports the user of the sliding transfer bench 100, and also supports the seat 120 and leg rest 130 of the sliding transfer bench 100. The bench frame 110 can be adjustable both in height and in length to accommodate various bathroom setups and users' height. The bench frame 110 includes a plurality of vertical members 111, which effectively serve as legs to support the sliding transfer bench 100. In the example of the sliding transfer bench 100 shown in the Figures, the bench frame 110 comprises four vertical members 111 supporting the sliding transfer bench 100, with two vertical members 111 arranged on each lateral end of the bench frame 110. However, in other embodiments, the vertical members 111 of the bench frame 110 may vary in number or form. For example, the bench frame 110 may alternatively include one or more vertical members 111 along the length of the sliding transfer bench 100 in addition to or in lieu of vertical members 111 at the lateral ends of the sliding transfer bench 100, or may comprise fewer or more than two vertical members 111 at the lateral ends.

At one lateral end of the bench frame 110, a horizontal connecting member 112, which can be arranged at or near the top of the vertical members 111, is provided, which spans and connects the two vertical members 111 at the lateral end. The horizontal connecting member 112 also may serve as a support handle for the user when embarking or disembarking from the seat 120 of the sliding transfer bench 100. At the opposite lateral end of the bench frame 110, a support handle 113 is provided, which can also be arranged at or near the top of the vertical members 111, and also spans and connects the two vertical members 111 at the lateral end. The user may use the support handle 113 to support themselves while in a bathtub or shower, to aid in sliding the seat 120 of the sliding transfer bench 100, or when embarking or disembarking from the seat 120. It is noted that in the example shown in the Figures, the horizontal connecting member 112 at one lateral end of the bench frame 110 is disposed below the height of the seat 120, and the support handle 113 at the opposing lateral end is disposed above the height of the seat 120. However, in other embodiments, the height of these elements may be reversed or changed, or the heights of the horizontal connecting member 112 and support handle 113 can be the same.

The bench frame 110 further comprises longitudinal rails 114, upon which the seat 120 rests and along which the seat 120 slides. In the sliding transfer bench 100 shown in the Figures, the bench frame 110 comprises two spaced apart longitudinal rails 114, and the longitudinal rails 114 extend from and connect opposing vertical members 111, spanning substantially the length (L₁) of the sliding transfer bench 100. In alternative embodiments, the longitudinal rails 114 may vary in number or configuration.

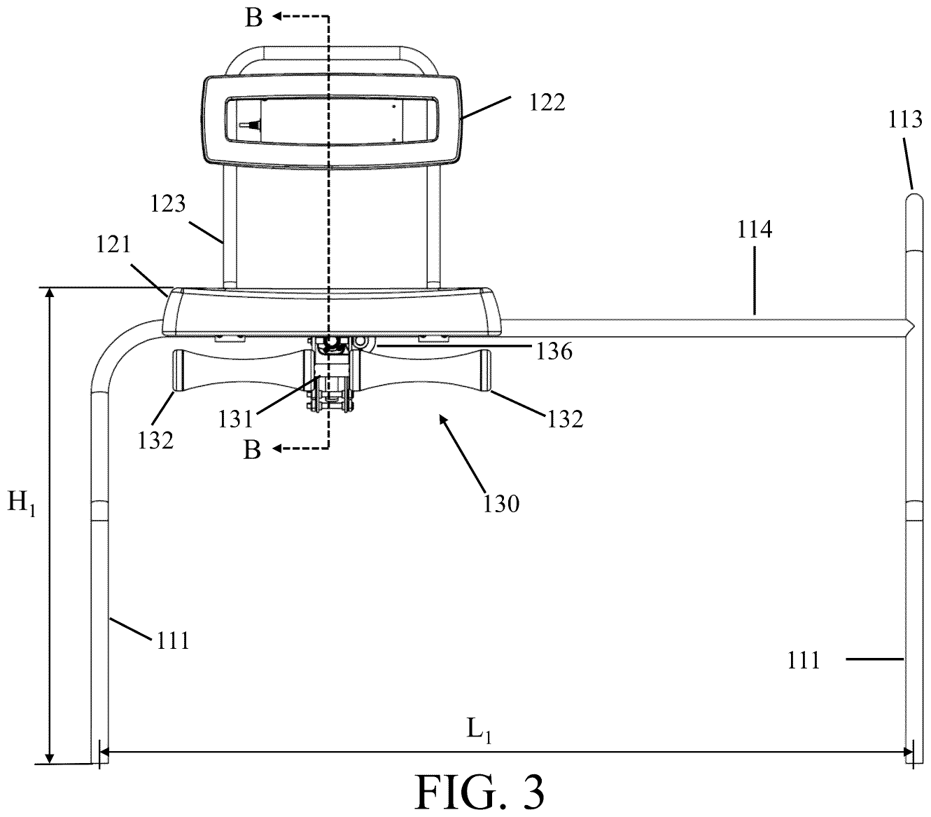

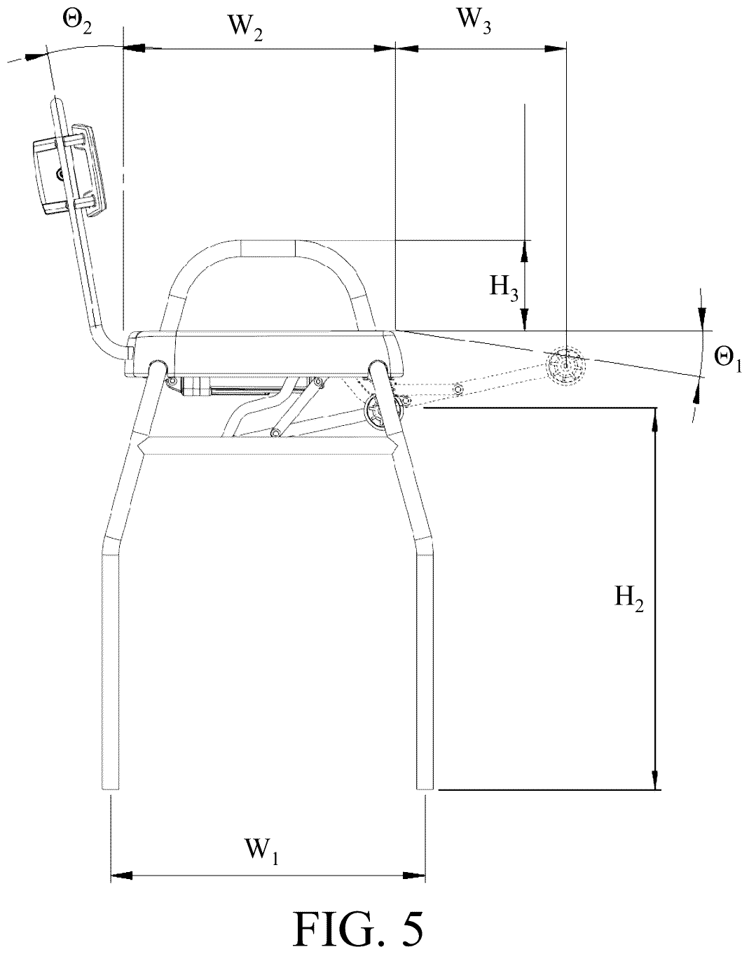

Various example dimensions of the bench frame 110 are identified in FIGS. 3 and 5. The length (L₁) of the sliding transfer bench 100 and bench frame 110 may be approximately 120 centimeters. The width (W₁) of the sliding transfer bench 100 and bench frame 110 may be approximately 48 centimeters. The height of the seat bottom 121 from the base of the bench frame 110 (H₁) may be approximately 70 centimeters. The height of the leg rest 130 from the base of the bench frame 110 (H₂) may be approximately 59 centimeters. The height of the support handle 113 from the seat bottom 121 (H₃) may be approximately 139 centimeters. It is noted that these dimensions are noted as one example set of dimensions, and in other embodiments, other dimensions may be utilized and the subject matter described herein is not limited to these dimensions.

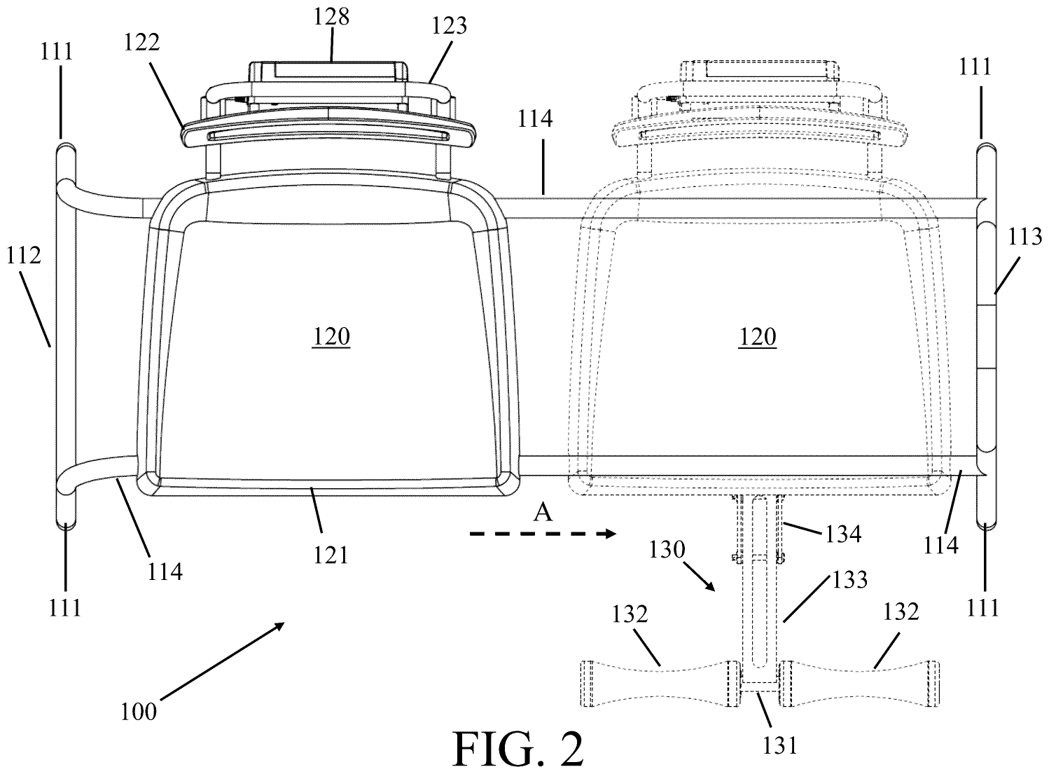

The sliding transfer bench 100 further comprises a seat 120, which as shown in FIG. 2 and noted above, is configured to slide in a lateral direction (A) along the longitudinal rails 114 of the bench frame 110, and in the reverse direction, to transport the user between lateral ends of the sliding transfer bench 100. The seat 120 can take various forms and configurations suitable to allow a user to sit on the sliding transfer bench 100, and is not limited to the configurations shown in the Figures, and described below.

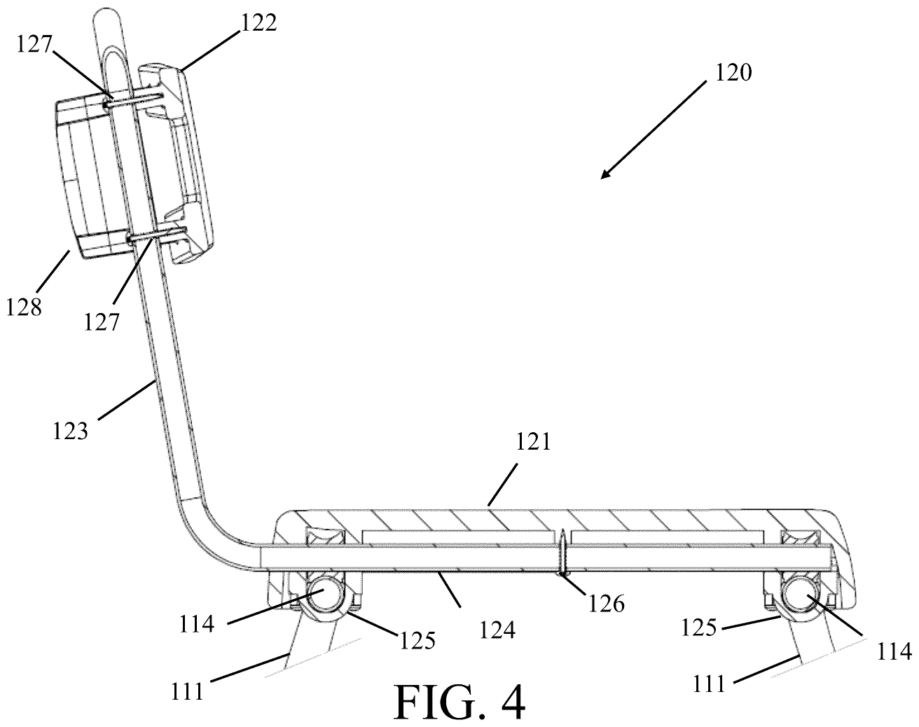

In the embodiments of the sliding transfer bench 100 shown in the Figures, the seat 120 comprises a seat bottom 121 on which the user sits, and a seat back 122 configured to support the user's back. The seat 120 comprises a frame, including a seat back frame 123, to which the seat back 122 is secured, and a seat bottom frame 124, to which the seat bottom 121 is secured. As shown for example in the cross-sectional view of FIG. 4 (along axis B-B identified in FIG. 3), the seat back frame 123 and seat bottom frame 124 may be the same component, or continuous, or interconnected rails, with the seat back frame 123 extending from the seat bottom frame 124, and being U-shaped. The seat back 122 may be secured to the seat back frame 123 by a plurality of threaded fasteners 127, passing through both the seat back 122 and the seat back frame 123. In other embodiments, the seat back 122 can be secured to the seat back frame 123 by snapping or gluing the seat back 122 onto the seat back frame 123. The seat bottom 121 may similarly be secured to the seat bottom frame 124 by a plurality of threaded fasteners 126, passing through both the seat bottom 121 and the seat back frame 123. The seat bottom 121 may further be configured with a plurality of seat mounts 125 configured to secure the seat bottom 121 to the longitudinal rails 114 of the bench frame 110. The seat bottom 121 may further comprise bearings (not shown) mounted in the seat bottom 121 that rotate along rails 114 to allow the sliding of the seat 120 on the bench frame 110. The seat mounts 125 may, for example, take the form of channels formed on the underside of the seat bottom 121, each of which is dimensioned for receiving a longitudinal rail 114 therethrough to secure the seat bottom 121 to the longitudinal rail 114 and the bench frame 110. The seat back 122 may be configured with battery pack 128 used in powering the actuator 136, as shown for example in FIGS. 1-5, but this feature may be omitted from other embodiments of the seat 120.

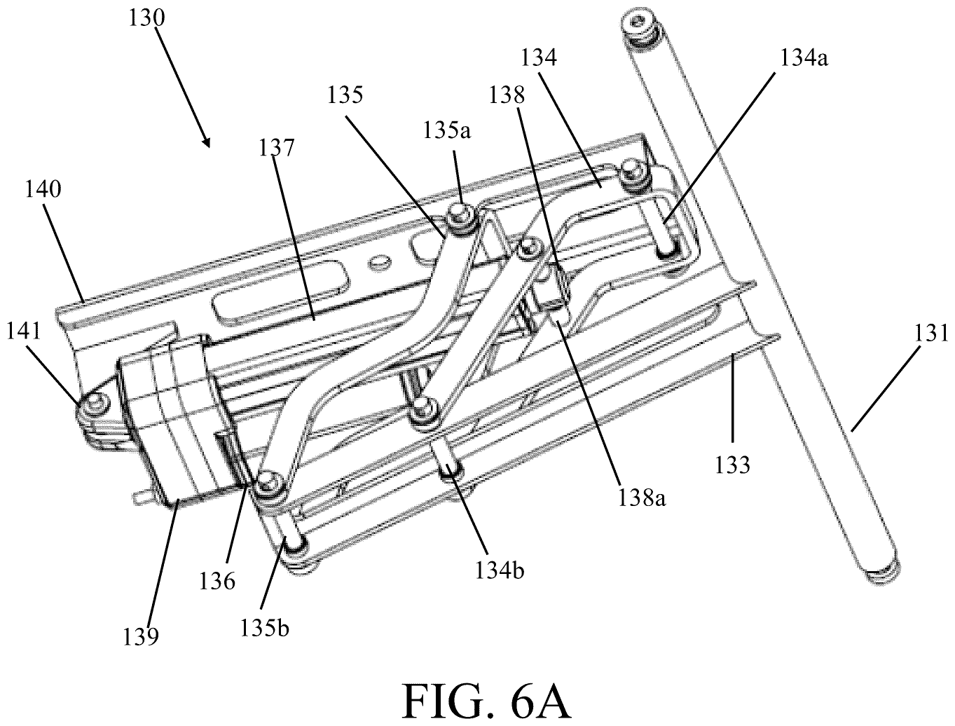

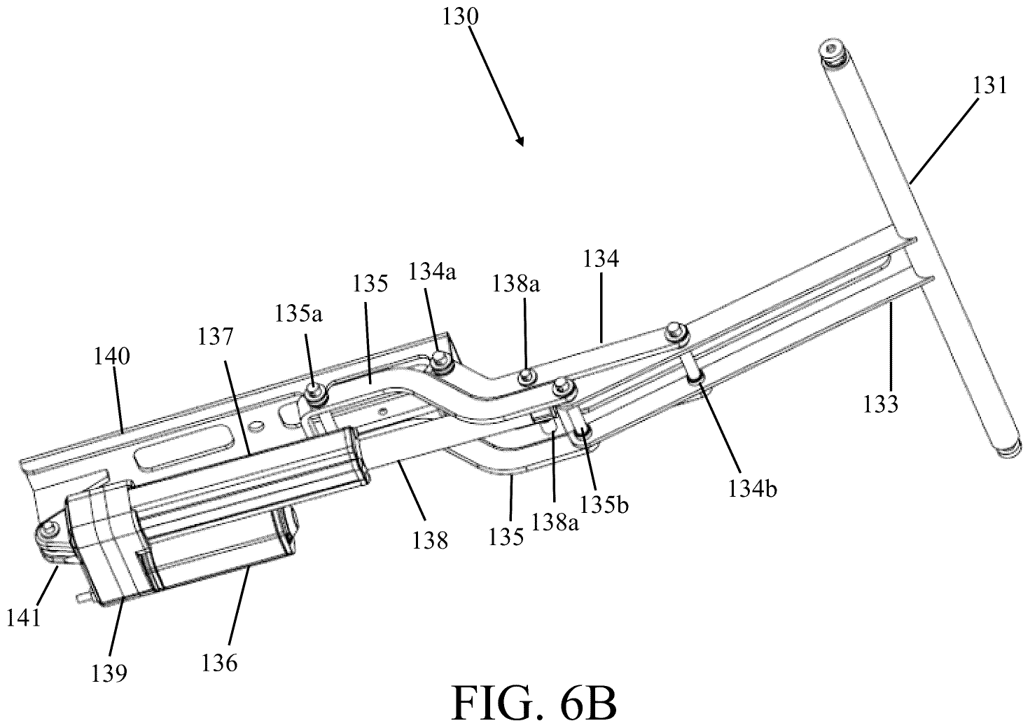

The sliding transfer bench 100 further comprises a retractable leg rest 130, arranged beneath the seat 120. The leg rest 130 is configured for actuation between a retracted position (FIG. 6A), in which it can be stored substantially beneath the seat 120, and an extended position (FIG. 6B), in which the leg rest 130 extends outwardly from the seat 120 to allow the user to support their legs while sliding laterally from one end of the bench frame 110 to the other. The leg rest 130 may comprise a leg rest mount 140, which is configured to mount the leg rest 130 to the seat 120. For example, the leg rest mount 140 may comprise a plurality of holes configured to receive a pin or bolt therethrough to mount the leg rest mount 140 to the underside of the seat 120. If attached to the seat 120, the leg rest mount 140 and leg rest 130 are then configured to move laterally with the seat 120 along the longitudinal rails 114 of the sliding transfer bench 100, allowing the user to move along the sliding transfer bench 100 with their legs in an elevated position. The seat bottom 121 may have dimensions of approximately 42 centimeters (W₂) by 46 centimeters, and the seat back may be formed at an angle (Θ₂) of approximately 10 degrees.

The leg rest 130 comprises a leg rest support 131 secured to a chassis 133, and upon which the user rests his or her legs during use. As shown for example in FIGS. 6A and 6B, the leg rest support 131, can be a bar or platform, and with the chassis 133, may collectively be T-shaped, with the leg rest support 131 being perpendicular to the chassis 133. The chassis 133 serves to connect the leg rest support 131 where the user rests his or her legs, to the other components of the leg rest 130 supplying the motion for extension and retraction, as discussed below.

In various embodiments of the leg rest 130, the leg rest support 131 has one or more roller 132 covering the bar, as shown for example in FIG. 1 and FIGS. 7 and 8. The rollers 132 are configured to rotate freely around the leg rest support 131 when set in movement, such as when the roller(s) contact the leg(s) of the user to extend outwardly or retract inwardly the leg rest 130. The rotation of the rollers 132 ensures a gentle, distributed pressure along the legs of the user instead of a steady point of contact that could create excessive friction on a given spot of the users' legs. This is especially important because the skin of users with mobility issues can be very delicate, and friction needs to be minimized or avoided. The point of contact of the rollers 132 moves along the leg and provides support while delivering a very smooth, controlled motion to extend the legs horizontally. The rollers 132 can be made of a soft material that provides a very comfortable experience to the user.

The leg rest 130 comprises a plurality of levers 134, 135, each of which is affixed at one end to the frame mount 140 and affixed at an opposite end to the chassis 133. In the embodiments illustrated in the FIGS. 6A-6B, there are two levers, including a first lever 134 and a second lever 135. The two levers 134, 135 are each substantially U-shaped and are part of the mechanism controlling the trajectory of the leg rest support 131 to provide stability while amplifying the stroke of the leg rest actuator 136 so the rollers 132 on the leg rest support 131 can travel all the way to the lower leg or ankle of the user and provide adequate support.

The first lever 134, which is arranged proximal to the leg rest support 131, comprises a first mount connector 134a configured to connect the first lever 134 to the leg rest mount 140, and comprises a first chassis connector 134b configured to connect the first lever 134 to the chassis 133. The first mount connector 134a and first chassis connector 134b may each comprise a bolt, pin or rod passing through overlapping holes in the first lever 134 and the chassis 133, respectively, which are secured in place by nuts on each end of the bolt, pin, or rod, as shown for example in FIGS. 6A and 6B. The second lever 135, which is arranged proximal to the actuator 136, comprises a second mount connector 135a configured to connect the second lever 135 to the leg rest mount 140, and comprises a second chassis connector 135b configured to connect the second lever 135 to the chassis 133. The second mount connector 135a and second chassis connector 135b may each comprise a bolt, pin, or rod passing through overlapping holes in the second lever 135 and the chassis 133, respectively, which are secured in place by nuts on each end of the bolt, pin, or rod, as shown for example in FIGS. 6A and 6B. It is noted that in FIGS. 6A and 6B, although only one face of the leg rest 130 is shown, on the opposite face the arrangement of the first lever 134 and second lever 135 and its mounting components would have a similar appearance.

The leg rest 130 further comprises an actuator 136. The actuator 136 can be an electric, hydraulic, pneumatic or a mechanical device. In the embodiment illustrated in the Figures, the actuator 136 is an electric actuator comprising a main body 137, a main shaft (or rod) 138, and an actuator motor 139. At rest and in the retracted position (FIG. 6A), the main shaft 138 is contained within the main body 137. When actuated, the main shaft 138 slides out and extends out of the main body 137 (FIG. 6B). The actuator 136 may comprise an activating device, such as a mechanical hand control or a remote controller configured to control the actuator 136.

The first lever 134 further comprises a shaft connector 138a, which secures an end of the main shaft 138 to the first lever 134. The shaft connector 138a may comprise a pin or rod passing through a hole in the main shaft 138 and corresponding holes in the first lever 134 in between the first mount connector 134a and the first chassis connector 134b. When the main shaft 138 is actuated and extends from the main body 137, the shaft connector 138a also extends with the main shaft 138, thereby pushing the first lever 134 outwardly (i.e., away from the actuator 136). As the first lever is connected to the chassis 133, this motion translates to the leg rest chassis 133 to extend the leg rest support 131 outwardly from the retracted position. The movement of the chassis 133 also translates to the second lever 135, which is also attached to the chassis 133 by way of the second chassis connector 135b. When the actuator 136 causes the main shaft 138 to retract, the motion of the first lever 134 occurs in reverse, as the main shaft 138 pulls the first lever 134 (and chassis 133, second lever 135, and leg rest support 131) inwardly in the opposite motion to the outward extension.

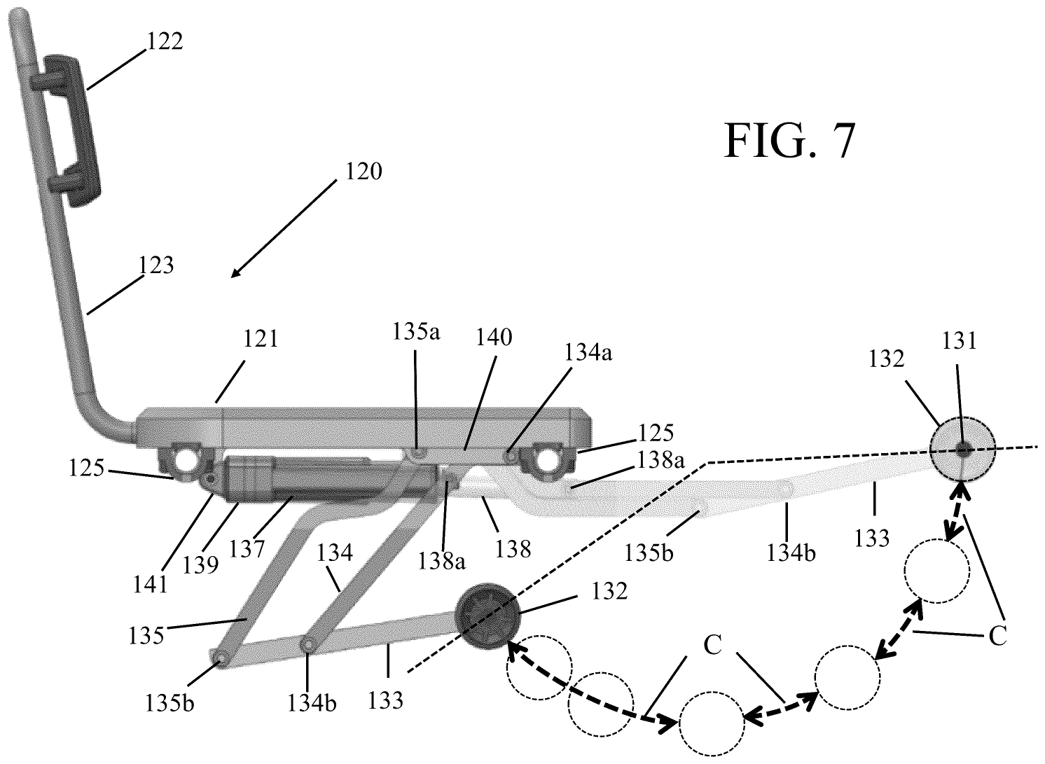

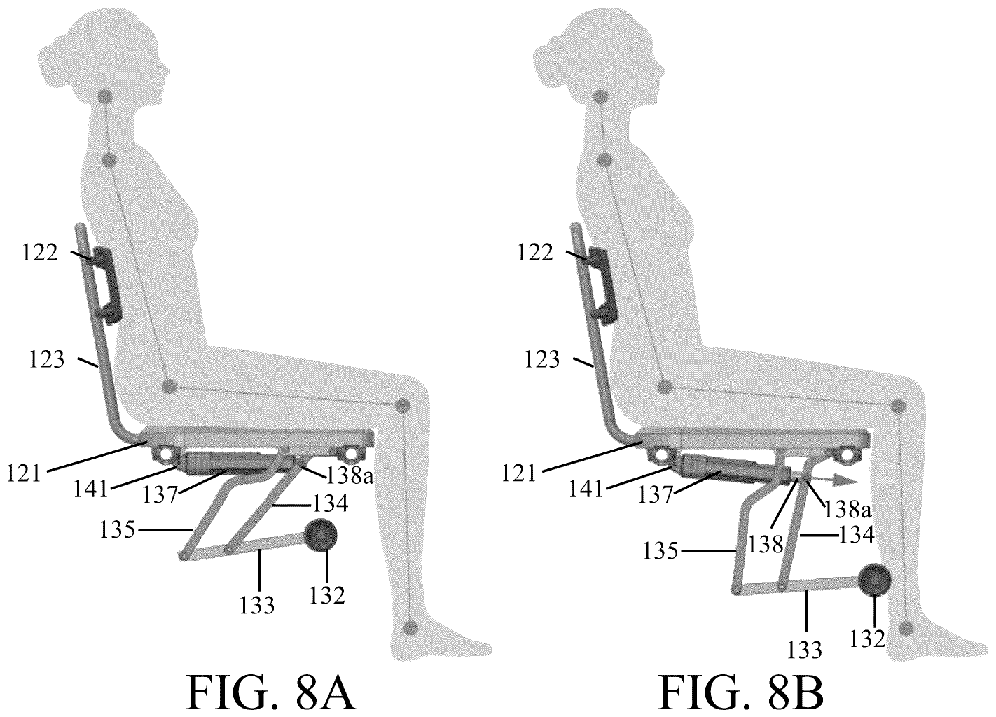

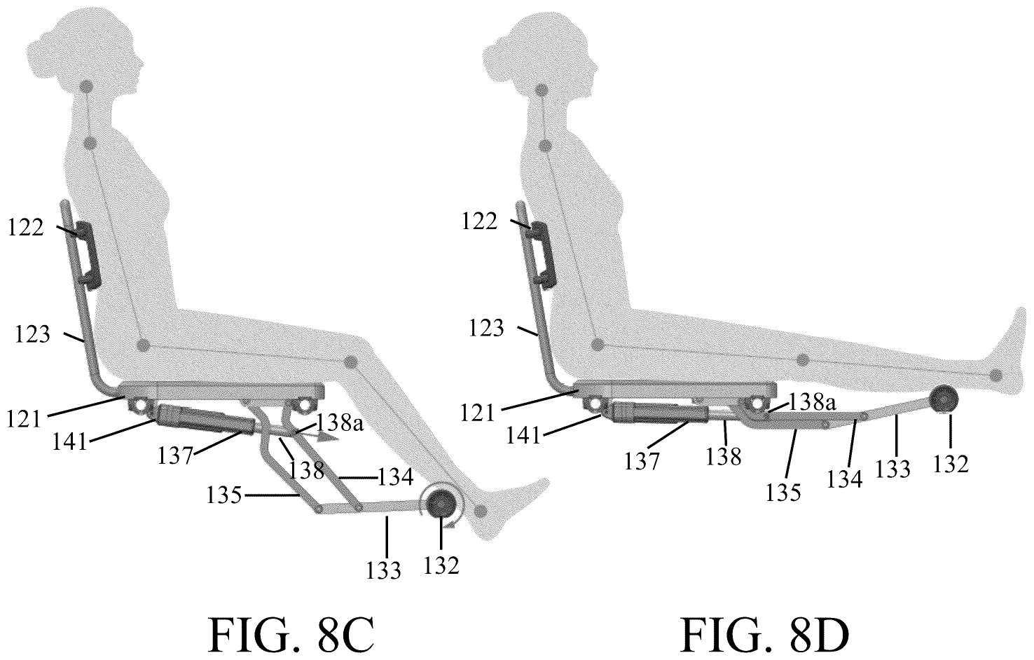

The first mount connector 134a and second mount connector 135a are statically secured to the leg rest mount 140, and do not move with the first or second lever 134, 135 but remain in a fixed position. The actuator 136 is connected to the leg rest mount 140 by a pivoting actuator mount 141 (also called a clevis), which allows the back end of the actuator 136 to freely rotate around that axis while the main shaft 138, at the other end, extends outwardly and drives the first lever 134 to start extending the leg rest, as shown for example between FIGS. 8A-8D. As shown in FIG. 7 for example, the extension mechanism of the main shaft 138 allows transformation of the linear stroke of the actuator 136 (movement of translation) into an elliptical movement arc (C) of the rollers 132 to allow their contact on the legs high enough (to accommodate a whole range of users). Retracting the main shaft 138 back into the main body 137 causes reverse elliptical movement (C).

An example of the use of the leg rest 130 is shown in FIGS. 8A-8D. The user may first sit in the seat 120 as would be typical, with his or her legs extending down from the seat 120, as shown in FIG. 8A. When actuated, the main shaft 138 of the actuator 136 of the leg rest 130 extends outwardly (i.e., away from the seat back 122), thereby pushing the first lever 134, the leg rest support 131 and rollers 132 outwardly from under the seat 120. The initial outward extension of the main shaft 138 results in the lowering of the leg rest support 131 and rollers 132, which contact the back of the user's lower legs, as shown in FIG. 8B. The main shaft 138, first lever 134, chassis 133, leg rest support 131 and rollers 132 continue their extension outward, pushing the user's legs upwardly while the rollers 132 move freely up the leg, as shown in FIG. 8C, until the main shaft 138 reaches its maximum extension from the main body 137, and the user's legs have been lifted horizontally, as shown in FIG. 8D. In the extended position, the leg rest 130 may extend outwardly from the seat 120 at a distance (W₃) of approximately 26 centimeters, and an angle (Θ₁) of seven degrees. For the user to lower his or her legs from the orientation shown in FIG. 8D, the leg rest 130 can be retracted by the actuator 136 retracting the main shaft 138 back inwardly (i.e., towards the seat back 122), in which case the motions of the leg rest 130 occur in reverse from the orientation in FIG. 8D, through the orientations in FIG. 8C and FIG. 8B, and to the fully retracted arrangement in FIG. 8A.

As used herein, directional, or positional terms such as “front”, “rear”, “upper”, “lower”, “top”, “bottom”, etc., are used for explanatory purposes only to describe the features relative to the orientation of the sliding transfer bench 100 shown on the page for example in FIGS. 1 and 3, and these terms are not intended to be limiting.

While there have been shown and described and pointed out fundamental novel features of the invention as applied to embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed:

1. An apparatus comprising:
a leg rest support, configured to move between an extended position and a retracted position and configured to support a user's legs when in the extended position;
an actuator configured to extend and retract linearly upon activation by an activating device; and
a chassis configured to connect the leg rest support to the actuator and configured to translate linear motion of the actuator into an arcuate motion of the leg rest support in between the extended position and the retracted position.

2. The apparatus of claim 1, where the leg rest support comprises one or more rollers arranged thereon, configured to roll along the user's legs during movement of the leg rest support.

3. The apparatus of claim 1, wherein the chassis comprises at least one opening therethrough.

4. The apparatus of claim 3, further comprising a first lever, the first lever comprising:
a first pin passing through a first lever opening configured to connect the lever to the chassis;
a second pin passing through a second lever opening configured to connect the first lever to the actuator; and
a third pin passing through a third lever opening configured to connect the first lever to a leg rest mount configured to mount the apparatus to another structure;
wherein the linear motion of the actuator translates to the first lever to cause the arcuate motion of the chassis and leg rest support.

5. The apparatus of claim 4, wherein the chassis further comprises a second opening therethrough configured to receive a pin of a second lever; the second lever being mounted to the leg rest mount.

6. The apparatus of claim 5, wherein the first lever and second lever are U-shaped.

7. The apparatus of claim 1, further comprising a chamber into which a rod of the actuator extends and retracts.

8. The apparatus of claim 1, wherein the activating device is electrically powered and comprises a rechargeable battery.

9. The apparatus of claim 1, wherein the activating device is hydraulically powered.

10. The apparatus of claim 1, wherein the activating device is mechanically powered.

11. The apparatus of claim 1, further comprising:
a leg rest mount configured to mount the apparatus to another structure; and
a clevis, configured to mount the actuator to the leg rest mount, and configured to rotate upon linear movement of the actuator and the arcuate motion of the leg rest support.

12. A sliding transfer bench comprising:
a bench seat;
a bench frame on which the bench seat rests and along which the bench seat is configured to slide laterally; and
a leg rest comprising:
a leg rest support, configured to move between an extended position and a retracted position and configured to support a user's legs when in the extended position;
an actuator configured to extend and retract linearly upon activation by an activating device; and
a chassis configured to connect the leg rest support to the actuator, and configured to translate linear motion of the actuator into an arcuate motion of the leg rest support in between the extended position and the retracted position.

13. The sliding transfer bench of claim 12, where the leg rest support comprises one or more rollers arranged thereon, configured to roll along the user's legs during movement of the leg rest support.

14. The sliding transfer bench of claim 12, wherein the chassis comprises at least one opening therethrough.

15. The sliding transfer bench of claim 14, further comprising a first lever, the first lever comprising:
a first pin passing through a first lever opening configured to connect the lever to the chassis;
a second pin passing through a second lever opening configured to connect the first lever to the actuator; and
a third pin passing through a third lever opening configured to connect the first lever to a leg rest mount configured to mount the leg rest to another structure;
wherein the linear motion of the actuator translates to the first lever to cause the arcuate motion of the chassis and leg rest support.

16. The sliding transfer bench of claim 15, wherein the chassis further comprises at least a second opening therethrough configured to receive a pin of a second lever; the second lever being mounted to the leg rest mount.

17. The sliding transfer bench of claim 16, further comprising:
a clevis, configured to mount the actuator to the leg rest mount, and configured to rotate upon linear movement of the actuator and the arcuate motion of the leg rest support.
